(19) United States
(12) Patent Application Publication
(10) Pub. No.: US 2025/0128992 A1
(43) Pub. Date: Apr. 24, 2025

(54) CHEMICAL RESISTANT POLYMER CONCRETE AND METHODS OF USE THEREOF

(71) Applicant: Composite Construction, LLC, Tucson, AZ (US)

(72) Inventors: Hamid Saadatmanesh, Tucson, AZ (US); Ehsan Mahmoudabadi, Tucson, AZ (US)

(21) Appl. No.: 19/001,051

(22) Filed: Dec. 24, 2024

Related U.S. Application Data
(63) Continuation-in-part of application No. 17/222,542, filed on Apr. 5, 2021, now Pat. No. 12,187,645.
(60) Provisional application No. 63/005,037, filed on Apr. 3, 2020.

(51) Int. Cl. C04B 41/48; C04B 41/00; C04B 41/63; C04B 103/60; C04B 111/60; C04B 111/72; C09D 163/10; E01C 7/14; E04C 5/07

(52) U.S. Cl. CPC C04B 41/4853; C04B 41/009; C04B 41/63; C09D 163/10; E04C 5/07; C04B 2103/60; C04B 2111/60; C04B 2111/72; E01C 7/142; E01C 7/145

(57) ABSTRACT

Chemical-resistant polymer concrete and methods of use thereof are described herein. The polymer concrete comprises a polymer layer and aggregates. The polymer layer is formed by reacting an epoxy vinyl ester resin promoted with cobalt and catalyzed by a peroxide. A concrete substrate is formed by layering the polymer layer and aggregates in thin alternating layers until a desired thickness is achieved. This layering method can reduce shrinkage of the concrete, thereby preventing cracking, deformation or debonding.

### CROSS REFERENCES TO PREVIOUS APPLICATIONS

This application is a continuation-in-part and claims benefit of U.S. application Ser. No. 17/222,542 filed Apr. 5, 2021, which is a non-provisional and claims benefit of U.S. Provisional Application No. 63/005,037 filed Apr. 3, 2020, the specification(s) of which is incorporated herein in their entirety by reference.

### FIELD OF THE INVENTION

The present invention relates to polymer concrete compositions and methods of forming concrete substrates.

### BACKGROUND OF THE INVENTION

Concrete is a composite material comprised of water, aggregates and cement. When mixed together, the components form a paste mixture that can be poured, molded, and then hardened by curing. Concrete is typically used in construction applications ranging from simple structures such as concrete blocks, walls, floors, and foundations to mega structures such as roads, pillars, bridges, and dams. Although concrete is a widely used building material, it is susceptible to substantial damage when exposed to acid conditions. Exposure to acid can erode and completely destroy the integrity of a concrete substrate and can turn it into rubble in a matter of hours, depending on the acid concentration. This issue is most problematic when concrete is used in acidic environments such as in mines, chemical plants, waste-water treatment facilities, acid blending facilities, etc.

One existing solution to minimize acid exposure is to apply acid-resistant coatings in the form of spray-on paint on the concrete substrate, thereby protecting it from acid attack. For example, epoxy, polyurethane and vinyl ester have been used as a top coating in thin-layers to coat and protect concrete and sometimes in association with sand that is broadcasted on top of the coated surface to create skid-resistance. However, a problem with this type of protection is that a very thin layer of coating is applied, and in the event that said layer is abraded or otherwise damaged due to surface impact, it provides a pathway for acid to reach the concrete surface and cause major damage. Hence, there exists a need to resolve the problem of acid damage to concrete substrates.

### BRIEF SUMMARY OF THE INVENTION

It is an objective of the present invention to provide chemical resistant polymer concrete and methods of forming concrete structures that are resistant to damage caused by exposure to acidic conditions, as specified in the independent claims. Embodiments of the invention are given in the dependent claims. Embodiments of the present invention can be freely combined with each other if they are not mutually exclusive.

In some aspects, the present invention features a polymer concrete that requires no coating and is completely resistant to acid attack. In one embodiment, the polymer concrete comprises multiple stacked composite layers. Each composite layer may comprise a polymer layer and an aggregate material disposed on the polymer layer. In some embodiments, the concrete can also be reinforced, if needed, with acid resistant carbon or glass fabrics or rods. Without wishing to be bound to a particular theory or mechanism, the present invention addressed the root cause of the acid damage problem by modifying the concrete itself. As a non-limiting example, the concrete composition may comprise a vinyl ester resin and silica or quartz. The vinyl ester resin can act as a binder to the aggregate material, thereby forming a polymer concrete without the impact and abrasion problems when sufficient thickness is achieved.

One of the unique and inventive technical features of the present invention is a method of laying a polymer concrete that reduces or eliminates any cracking, deformation or debonding. The methodology involves building the polymer concrete layer by layer to achieve a final desired thickness. Without wishing to limit the invention to any theory or mechanism, it is believed that the technical feature of the present invention advantageously provides for decreased shrinkage due to bulk application while still producing an acid resistant concrete with the desired thickness. None of the presently known prior references or work has the unique inventive technical feature of the present invention. Furthermore, the inventive technical features of the present invention is counterintuitive. The reason that it is counterintuitive is because the feature of the present invention contributed to a surprising result. One skilled in the art is aware that a problem that arises from applying concrete is that when it is laid in thick layers, the polymer binder will shrink due to the large volume involved, causing significant cracking and deformation which will result in an unacceptable outcome of the concrete having no bond to a surface. Surprisingly, the application of layers in the method of the present invention results in a polymer concrete of any desired thickness with no shrinkage or cracking. Thus, the feature of the present invention is counterintuitive.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a non-limiting embodiment of the present invention in which a polymer concrete is comprised of multiple composite layers.

FIG. 2 shows a non-limiting embodiment of the polymer concrete having reinforcing material disposed in the composite layers.

FIG. 3 is a flow diagram of forming the multi-layer polymer concrete.

FIG. 4 shows a non-limiting schematic for repairing a surface.

### DETAILED DESCRIPTION OF THE INVENTION

Following is a list of elements corresponding to a particular element referred to herein:
10 pre-existing floor
15 repaired floor
100 polymer concrete
105 composite layer
110 polymer layer
120 aggregate
140 reinforcing material

As used herein, the term “substrate” can refer to a free-standing structure or a coating. For example, the free-standing structure may be a backer board. As another example, the substrate may be a top coating applied to a pre-existing surface.

As used herein, the term “dry” refers to a state where a composite layer of the polymer concrete is substantially tack-free. One of ordinary skill in the art would understand that “tack-free” refers to a state where the composite layer is sufficiently robust to resist damage by touch or settling dirt. Tack-free time refers to a period from the start of cure to a point when the composite layer is tack-free. Tack-free can be determined as the point when the surface no longer feels sticky. In a more definitive method, it can be determined by briefly pressing a polyethylene film against the surface and checking for any adhering material when the film is removed.

In preferred embodiments, where the surface has a large surface-area, for example, basement floor, garage floor, or road, the subsequent composite layers are added when the previous composite layer is tack-free so that workers are able to walk on the surface of the previous composite layer. Depending on environmental conditions, such as ambient temperature and relative humidity, the tack-free time may range from about 1 hour to at least 24 hours. For example, the next composite layer may be laid about 2 hours after the previous composite layer in a dry environment at 75° F. As another example, the next composite layer may be laid about 4-6 hours after the previous composite layer in an environment at 80° F. and 90% humidity.

As used herein, the term “cure” refers to a state when the polymer concrete has set and hardened. Cure may be considered to be achieved when the polymer binder is at least 70% cross-linked. Over time, the polymer concrete can achieve 90% cross-linking. The term “cure” is not the same as “dry” or “tack free”. The composite layer may be dry or tack-free, but not cured.

As used herein, the term “broadcasting to the point of refusal” means that the aggregates are applied on the polymer layer until the aggregates no longer stick to the polymer coating, e.g. extra aggregate can be removed via sweeping or vacuuming when the composite layer is tack-free.

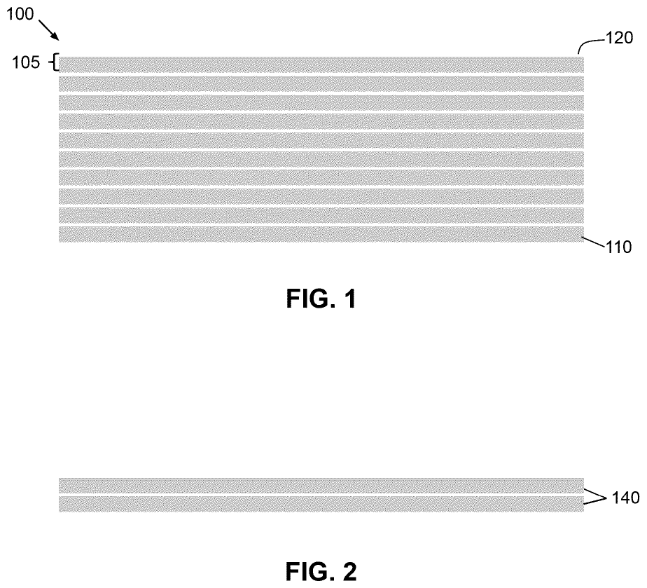

Referring now to FIGS. 1-2, in some embodiments, the present invention features a polymer concrete (100) comprising multiple stacked composite layers (105). Each composite layer (105) may comprise a polymer layer (110), and an aggregate material (120) disposed on the polymer layer (110). As shown in FIG. 1, one of ordinary skill in the art would understand that the aggregate material is disposed on the polymer layer (110) such that some of the aggregate particles may be completely disposed in the coating, some may be protruding out of the surface, and some may be on top of the coating.

In preferred embodiments, the polymer concrete (100) is resistant to acid attack. For example, the polymer concrete (100) is resistant to deterioration when exposed to acidic compounds having a pH lower than 7. In other preferred embodiments, the polymer concrete (100) is resistant to cracking, debonding, or deformation.

In some embodiments, the polymer concrete (100) comprises at least two stacked composite layers (105). For example, the number of composite layers (105) can range from 2 to 20 layers. In some embodiments, the number of composite layers (105) can range from 2 to 50 layers. In some embodiments, a thickness of each composite layer can range from about 1 mm to about 9 mm. In a preferred embodiment, the thickness of each composite layer is about 1 mm to about 5 mm. In another preferred embodiment, the thickness of each composite layer is about 2 mm to about 3 mm. At most, the thickness of each composite layer is 9 mm. In a non-limiting embodiment, the polymer concrete (100) may comprise ten composite layers (105) that have a combined thickness of about 1 inch or more. In another non-limiting embodiment, the polymer concrete (100) may comprise ten composite layers (105) that have a combined thickness of about 1 centimeter or more.

According to some embodiments, the polymer layer (110) is prepared from a polymer composition comprising a vinyl ester and a peroxide. The peroxide acts as a catalyst or initiator in the curing process (cross-linking) of the vinyl ester resin. In one embodiment, the polymer composition may comprise at least 90 wt % of the vinyl ester resin and about 0.5 wt % to about 5 wt % of the peroxide. In some embodiments, the polymer composition may comprise at least 75 wt % of the vinyl ester resin and about 0.05 wt % to about 10 wt % of the peroxide. A non-limiting example of the vinyl ester resin is a novolac epoxy vinyl ester resin. Examples of the peroxide include, but are not limited to, methyl ethyl ketone peroxide, cumene hydroperoxide, and benzoyl peroxide.

In some embodiments, the polymer composition may include about 0.05 wt % to about 0.5 wt % of a promoter. In some embodiments, the polymer composition may include about 0.01 wt % to about 1 wt % of the promoter. The promoter is added to the vinyl ester resin to produce the curing reaction (e.g. gelling) and control cure times and characteristics. Non-limiting examples of promoters include dimethylaniline, diethylaniline, and cobalt promoters such as cobalt naphthenate and cobalt octoate. For instance, the promoter may comprise about 5 wt % to about 15 wt % of cobalt. In some embodiments, the promoter may comprise about 1 wt % to about 25 wt % of cobalt.

In some embodiments, the polymer layer (110) is prepared from a polymer composition comprising at least 90 wt % of another resin. In some embodiments, the polymer composition comprises at least about 75 wt % to about 95 wt % of another resin. The polymer composition may further include initiators and promoters as previously described.

In some embodiments, the aggregate material (120) may comprise quartz, silica, or a combination thereof. For example, the aggregate material (120) is sand. The aggregate material (120) can have a grit size ranging from about 16 grit to about 60 grit. As known to one of ordinary skill in the art, higher grit numbers correspond to a finer particle size.

In some embodiments, the polymer concrete (100) may further comprise a reinforcing material (140) disposed in at least one of the composite layers (105). Depending on the desired reinforcement, all of the composite layers may contain the reinforcing material or only some of the composite layers may contain the reinforcing material. In one embodiment, the reinforcing material (140) may be disposed between the polymer layer (110) and the aggregate material (120). In another non-limiting embodiment, the reinforcing material (140) may be disposed within a layer of the aggregate material (120). In another non-limiting embodiment, the reinforcing material (140) may be disposed within the polymer layer (110). Examples of the reinforcing material (140) include, but are not limited to, carbon and glass fabric or rods. In preferred embodiments, the reinforcing material (140) is acid-resistant.

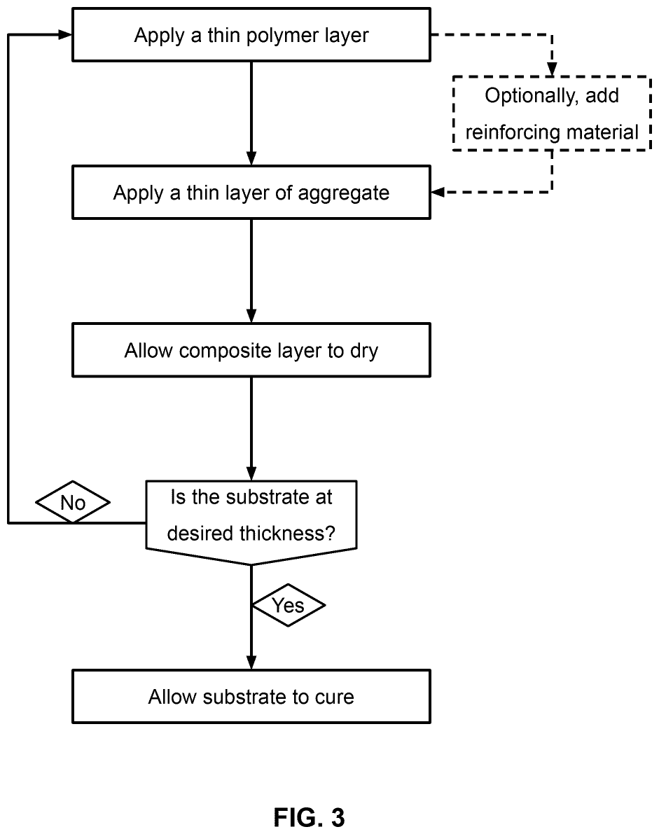

In some embodiments, the polymer concrete (100) described herein may be produced using methods that improve the structural integrity of the substrate. Accordingly, the present invention provides a novel method of forming the polymer concrete (100) as demonstrated in FIG. 3. The method may comprise laying a first polymer layer (110), applying a layer of aggregate material (120) on the first polymer layer (110), thereby forming a composite layer (105), allowing said composite layer (105) to dry until substantially tack-free, applying a polymer layer (110) on the previous composite layer (105), applying a layer of aggregate material (120) on said polymer layer (110), thereby forming another composite layer (105), and allowing said composite layer (105) to dry until substantially tack-free. The steps of applying a polymer layer (110) on the previous composite layer (105), applying a layer of aggregate material (120) on said polymer layer (110) to form another composite layer (105), and allowing said composite layer (105) to dry until substantially tack-free are repeated until a desired thickness of the polymer concrete (100) is achieved. Once the desired thickness is achieved, the polymer concrete (100) is allowed to cure.

In preferred embodiments, the polymer concrete (100) is acid resistant. Contrary to conventional procedures where the polymer layer is applied in thick layers, the present invention applies the polymer layer in thin layers. Without wishing to limit the present invention, this method is effective for reducing shrinkage of the polymer layer, thereby preventing cracking, debonding, or deformation of the polymer concrete. In some embodiments, the polymer layer may be at most a third of the thickness of the corresponding aggregate layer. In some embodiments, the polymer layer may be 1/20 to ⅓ of the thickness of the corresponding aggregate layer. In some embodiments, the polymer layer may be at most half of the thickness of the corresponding aggregate layer. In some embodiments, the polymer layer may be 1/20 to ½ of the thickness of the corresponding aggregate layer. In this context, the “corresponding aggregate layer” of a polymer layer refers to an aggregate layer disposed adjacent to (above or below) the polymer layer.

In some embodiments, the thickness of each composite layer ranges from about 1 mm to about 9 mm. For example, the thickness of each composite layer may be about 2 mm to about 4 mm. In some embodiments, the number of composite layers (105) ranges from 2 to 20. In some embodiments, the number of composite layers (105) can range from 2 to 50 layers. For example, the layering process may be repeated 6 to 8 times so as to produce a polymer concrete with 8 to 10 layers. In a non-limiting embodiment, the polymer concrete may have 8 to 10 layers for a total thickness of about 1 inch or more. In another non-limiting embodiment, the polymer concrete (100) may comprise ten composite layers (105) that have a combined thickness of about 1 centimeter or more.

In some embodiments, the step of applying the layer of aggregate material (120) on the polymer layer (110) may comprise broadcasting the aggregate material (120) to the point of refusal. Excess aggregate material (120) may be removed after the point of refusal although it is not required. The excess aggregate material (120) can be removed by vacuuming or sweeping.

In further embodiments, the method may include reinforcing the polymer concrete (100) by adding a reinforcing material (140) in at least one of the composite layers (105). Preferably, the reinforcing material (140) is added to the polymer layer (110) prior to applying the layer of aggregate material (120). In one embodiment, the reinforcing material (140) may be disposed between the polymer layer (110) and the aggregate material (120). In another non-limiting embodiment, the reinforcing material (140) may be disposed within a layer of the aggregate material (120). In another non-limiting embodiment, the reinforcing material (140) may be disposed within the polymer layer (110).

In some embodiments, the polymer concrete (100) can be formed on a pre-existing surface (10), such as a floor or road. The pre-existing surface (10) may be cleaned and/or leveled prior to adding the polymer concrete (100). In another non-limiting embodiment, the polymer concrete may be added to the pre-existing surface (10) without cleaning and/or leveling beforehand. Thus, the method of the present invention can be used to repair a pre-existing surface (10).

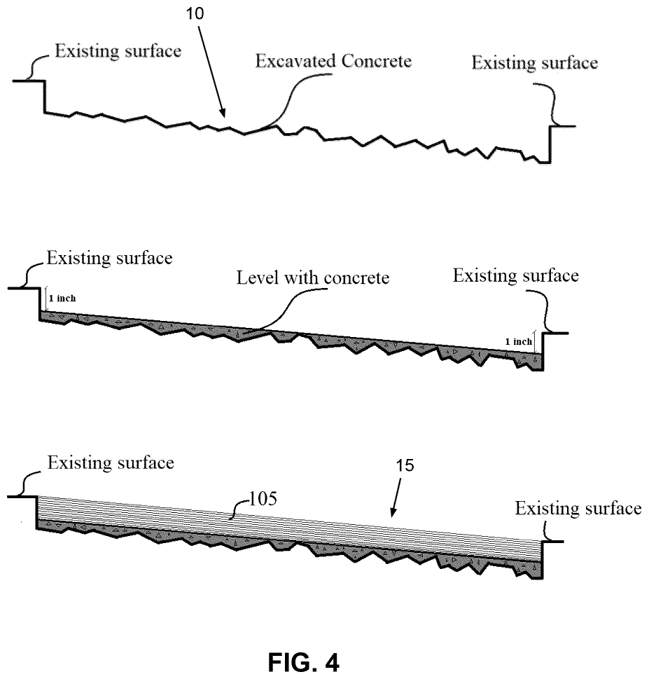

Referring to FIG. 4, in some embodiments, the present invention features a method of repairing a pre-existing surface (10). The method may comprise laying a first polymer layer (110) on the pre-existing surface (10), applying a layer of aggregate material (120) on the first polymer layer (110), thereby forming a composite layer (105), allowing said composite layer (105) to dry until substantially tack-free, applying a polymer layer (110) on the previous composite layer (105), applying a layer of aggregate material (120) on said polymer layer (110), thereby forming another composite layer (105), and allowing said composite layer (105) to dry until substantially tack-free. The steps of applying a polymer layer (110) on the previous composite layer (105), applying a layer of aggregate material (120) on said polymer layer (110) to form another composite layer (105), and allowing said composite layer (105) to dry until substantially tack-free are repeated until a desired thickness of the stacked composite layers is achieved, thereby forming a repaired surface (15) that is acid resistant. Without wishing to limit the present invention, the method reduces shrinkage of the polymer coating, thereby preventing cracking, debonding, or deformation of the stacked composite layers.

In some embodiments, the method further comprises cleaning and leveling the pre-existing surface (10) prior to adding the first polymer layer (110). The pre-existing surface (10) can be leveled by applying concrete to the pre-existing surface. In another non-limiting embodiment, the polymer concrete may be added to the pre-existing surface (10) without cleaning and/or leveling beforehand.

In preferred embodiments, the thickness of the stacked composite layers is such that the top-most composite layer is flushed or leveled with an adjacent surface that was not repaired. In other words, the top-most composite layer and the surrounding surfaces lie on the same plane.

### Example

The following are non-limiting examples of the present invention. It is to be understood that said examples are not intended to limit the present invention in any way. Equivalents or substitutes are within the scope of the present invention.

### Example 1. Preparing the Polymer Composition

1. To about 95 wt % of a novolac epoxy vinyl ester resin, mix in about 0.5 wt % of a promoter comprising about 15 wt % of cobalt.
2. Mix in about 4.5% of methyl ethyl ketone peroxide to the promoted novolac epoxy vinyl ester resin.

### Example 2. Preparing the Polymer Composition

1. To about 97 wt % of a novolac epoxy vinyl ester resin, mix in about 0.2 wt % of a promoter comprising about 10 wt % of cobalt.
2. Mix in about 2.8% of methyl ethyl ketone peroxide to the promoted novolac epoxy vinyl ester resin.

### Example 3. Floor Repair

1. Remove damaged sections of concrete floor and clean debris.
2. Add cement to the sections such that a smooth and leveled surface is formed and the depth of the sections is about 1 inch.
3. Lay a first polymer layer about 3 mm thick.
4. Broadcast 16 grit sand to the point of refusal.
5. Allow polymer layer to dry until tack-free.
6. Lay another polymer layer about 3 mm thick.
7. Broadcast 16 grit sand to the point of refusal.
8. Allow polymer layer to dry until tack-free.
9. Repeat steps 6-8 until the surface of the top-most layer is at the same level as the undamaged sections of concrete floor.
10. Cure the repaired sections.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A concrete composition comprising alternating layers of polymer (110) and aggregate material (120).

2. The concrete composition of claim 1, wherein a number of layers (105) ranges from 2 to 40.

3. The concrete composition of claim 1, wherein the composition is acid resistant

4. The concrete composition of claim 1, wherein the polymer comprises at least 90 wt % of a vinyl ester resin, and about 0.5 wt % to about 5 wt % of peroxide.

5. The concrete composition of claim 4, wherein the polymer composition further comprises about 0.05 wt % to about 0.5 wt % of a promoter.

6. The concrete composition of claim 1, wherein the polymer comprises at least 90 wt % of an epoxy or polyurethane resin.

7. The concrete composition of claim 1, wherein the aggregate material (120) comprises quartz, silica, or a combination thereof.

8. The concrete composition of claim 1, wherein the aggregate material (120) has a grit size of about 16 grit to about 60 grit.

9. The concrete composition of claim 1, wherein a thickness of each composite layer ranges from about 1 mm to about 9 mm.

10. The concrete composition of claim 1, further comprising a reinforcing material (140) disposed in at least one of the composite layers (105).

11. The concrete composition of claim 10, wherein in the reinforcing material (140) comprises carbon or glass fabric or rods.

12. The concrete composition of claim 10, wherein the reinforcing material (140) is disposed between the polymer (110) and the aggregate material (120).
